(19) United States
(12) Patent Application Publication
(10) Pub. No.: US 2025/0265161 A1
(43) Pub. Date: Aug. 21, 2025

(54) DYNAMICAL LOCKING OF SEED VALUE FOR LFSR DESCRAMBLER FOR USB

(71) Applicant: Tektronix, Inc., Beaverton, OR (US)

(72) Inventors: Archana I. Akkalakot, Bengaluru (IN); Alka Kumari, Bengaluru (IN)

(21) Appl. No.: 19/053,083

(22) Filed: Feb. 13, 2025

(30) Foreign Application Priority Data
Feb. 21, 2024 (IN) 202421012230

(51) Int. Cl. G06F 11/22

(52) U.S. Cl. CPC G06F 11/221

(57) ABSTRACT

A test and measurement instrument has one or more channels to receive data from a device under test through a test fixture, the data being transmitted by the DUT in accordance with the Universal Serial Bus protocol 3.x, and one or more processors to: acquire a state of a linear feedback shift register (LFSR), extract a known portion of the LFSR as an LFSR value; shift the LFSR value a predetermined number of times to produce a new value of the LFSR, compare the new value of the LFSR to a value of incoming data to determine if the incoming data comprises a potential control code, repeat to acquire a predetermined number of potential control codes, compare them to known control code values to determine if they are valid, and if so, lock a seed used to descramble the remaining incoming data.

### CROSS-REFERENCE TO RELATED APPLICATIONS

This disclosure claims priority under 35 U.S.C. § 119 to Indian Provisional Patent Application No. 202421012230, titled “DYNAMICAL LOCKING OF SEED VALUE FOR LFSR DESCRAMBLER FOR USB,” filed on Feb. 21, 2024, the disclosure of which is incorporated herein by reference in its entirety.

### TECHNICAL FIELD

The present disclosure relates to communication systems. The disclosure, more particularly, relates to the field of digital communication and signal processing.

### BACKGROUND

Generally, USB (Universal Serial Bus) is an industry standard widely used for data and power exchange between different devices. There have been several standard evolutions in recent years for USB to support higher data rates and also port expansion at better speed. The key advantages of using USB buses are low cost, bi-directional data transfer, backward compatibility to low-mid-high speed.

There are different USB standards available in the market. Initially USB 1.0 was invented to support two speeds 1.5 Mbps (Mega bits per second) and 12 Mbps for peripheral interface. With the evolution of powerful personal computers (PCs) with larger data exchange rate, USB 2.0 has been introduced which supported speed up to 480 Mbps while supporting backward compatibility. The current state of the market includes the following USB standards: USB 1.0 Low (1.5 Mbps) and High (12 Mbps), USB 2.0 Full (12 Mbps), USB 3.0 (5 Gbps), and USB 3.0 Gen 2 (10 Gbps).

Furthermore, with the evolution of wired and wireless technology and other new market needs, USB 3.x standards emerged to meet the requirement of higher data rates and to support increased bandwidth as well.

To increase the bandwidth to support higher data rates, the USB standards adopted different line encodings and data formats like 8b/10b. 128b/132b, 64/66b etc.

As part of the prior art the USB 3.2 Gen2 follows different states before data transmission starts. However, the problem with baseband signals is transmitting continuous 1's or 0's leads to errors on the receiver side and also adds difficulty in clock recovery. Hence data scrambling is used to reduce EMI (Electro Magnetic Induction) or peak emissions.

Therefore, USB 3.2 Gen 2 uses 23-bit scrambler on the transmitter side to overcome EMI which will be encoded using 128b/132b.

However, the problem while using the USB 3.2 Gen 2 uses 23-bit scrambler is it takes a lot of time to find the right seed, which slows down the decoding process.

### BRIEF DESCRIPTION OF ACCOMPANYING DRAWINGS

FIG. 1 shows a test and measurement instrument in a test set up using a probe to receive data from a device under test (DUT).

FIG. 2 shows different steps in a process to perform link and initialization training for Universal Serial Bus (USB) 3.2 Gen 2.

FIG. 3 shows the different steps in decoding a USB 3.2 Gen 2 signal using a 23-bit scrambler on the transmitter side.

FIG. 4 shows a flowchart of an embodiment of a method to decode data transmission under USB 3.x.

FIG. 5 shows an example of decoded data for the idle pattern.

FIG. 6 shows an example of decoded data for the idle pattern.

### DETAILED DESCRIPTION

The embodiments herein involve a test and measurement instrument and method to descramble, or decode, Universal Serial Bus (USB) 3.2 Gen 2 waveforms after the standard-defined link initialization and training process. The embodiments accomplish the descrambling without needing extra probes or additional channels of the instrument to capture sideband signals to use for decoding. The embodiments also avoid complicated and lengthy search algorithms to find the correct seed to use in decoding. The below discussion focuses on USB 3.2 Gen2, but the embodiments described herein may apply to future USB standards. The discussion will therefore refer to the standard as USB 3.2 gen 2 and later USB versions as “USB 3.X.”

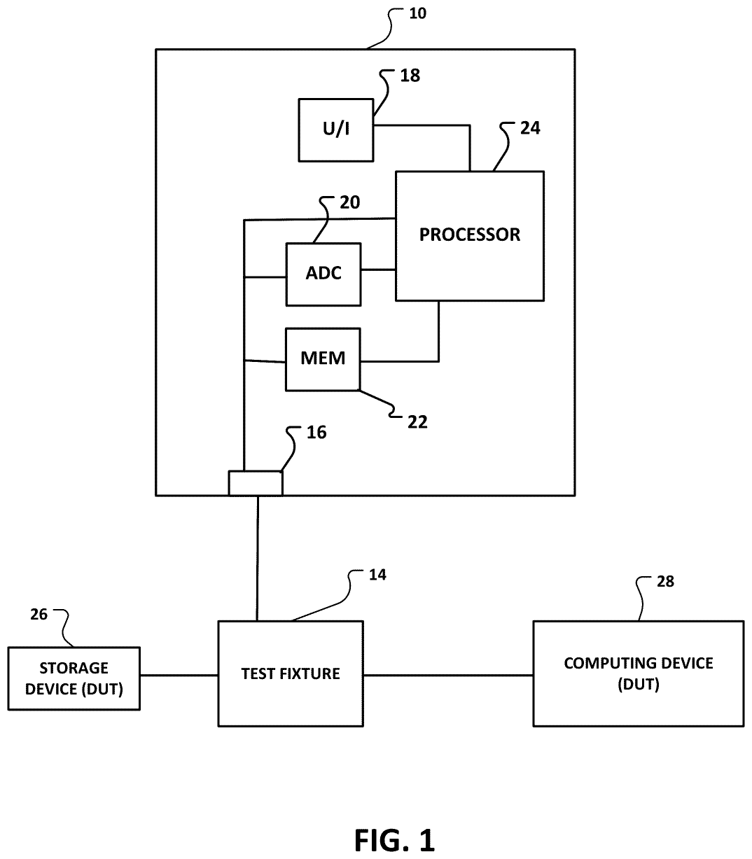

FIG. 1 shows an example situation in which the USB communications may need to undergo descrambling, which the discussion may also refer to as decoding. The test and measurement instrument 10 connects to a text fixture 14 that is in turn connected to a computing device 28 and a storage device 26. The connection may involve one or more probes on the test fixture. While these will both be referred as DUTs, the descrambling operation applies to whichever of the computing device 28 or the storage device 26 is transmitting the data. The test fixture 14 sends the USB data through one or more channels 16 on test and measurement instrument 10. In some embodiments, the test fixture 14 may comprise a probe. As discussed above, the embodiments herein will typically only use one probe and one channel of the instrument, but more may be used.

The data from the test fixture 14, if analog, undergoes conversion to digital by one or more analog-to-digital converters (ADC), such as ADC 20. The ADC 20 converts the analog data to digital data for the one or more processors such as processor 24 to operate upon the digital data. If the data received comprises digital data, the digital data bypasses ADC 20. The test and measurement instrument 10 may include a memory 22 to allow the one or more processors 24 to store the digital and analog data and may contain the code to be executed by the one or more processors 24. User interface 18 allows the test and measurement instrument 10 to display at least the resulting current measurement to the user, and may include controls such as buttons, knobs, sliders, trackballs, etc., to allow the user to perform operations on the incoming signals, etc.

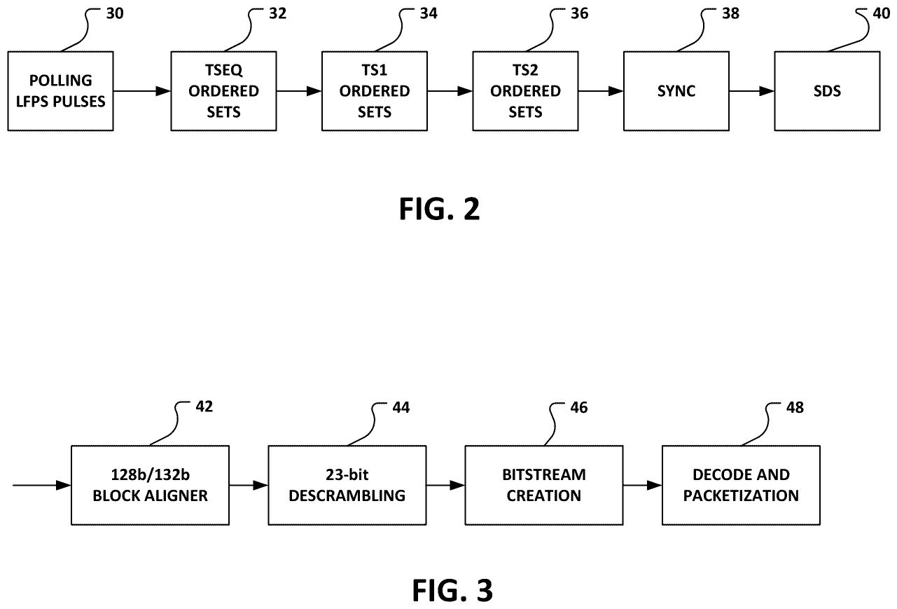

Currently, the USB 3.2 Gen2 standard performs a link initialization and training mode to negotiate and establish the link. For link Initialization and training mode different training sequences are sent on the bus to negotiate/establish the link. In FIG. 2 at 30, the sequences start with low frequency pulse stimulation (LFPS). The training sequences TSEQ 32 (training set equalizer), TS1 34, and TS2 36, occur to train the link between the USB device 26 and the computing device 28 to which the USB device is connected, as shown in FIG. 1. After the training sequences, the SYNC signal at 38 indicates data transmission (SDS) at 40.

Issues arise with the baseband signals because, while the training sequences involve sending continuous 1's or 0's, the electromagnetic induction (EMI) and peak emissions across the connections lines can lead to errors. Data scrambling reduces these errors.

Data scrambling in USB 3.2 Gen 2 uses a 23-bit scrambler on the transmitter side to overcome EMI which is encoded using 128b/132b, before the final data has been sent to devices on the receiver side. The discussion here uses the term “descrambling” and “decoding” interchangeably, meaning the process to convert the scrambled data to unscrambled data recognizable by the receiver.

FIG. 3 shows a block diagram depicting different steps used to decode USB 3.2 Gen2 signal. The first step of signal decoding occurs at 42 in which the Gen2 signal operates at 10 Gbps (Giga bits per second), the received data contains 132 bits in which 4-bit block identifier is either control (1100) or data (0011) blocks prepended to be 16 symbols (128 bits) to create 128b/132b line encoding.

At 44, descrambler uses 23-bit polynomial for data descrambling. The polynomial can be expressed as:

$${X}^{23} + {X}^{21} + {X}^{16} + {X}^{8} + {X}^{5} + {X}^{2} + 1$$

The descrambler logic uses the Linear Feedback Shift Register (LFSR) mentioned above, which is a 23-bit register. The initial state of the LFSR is 0x1dbfbc. There are certain rules that 3.2 Gen2 communications follow for descrambling and creation of the bitstream at 46 that is then decoded and packetized at 48.

The rules for descrambling result from the scrambling process. First, the 4 bits of the Block Header bypass the scrambler and do not advance the scrambler. Second, the training sequences are TS1, TS2 and TSEQ. Symbol 0 of a TS1, TS2, or TSEQ Ordered Set bypass and advances the scrambler. Symbols 1 to 13 are scrambled. Symbols 14 and 15 bypass the scrambler and the scrambler advances if being used for direct current (DC) balance. If they are not being used for DC balance, then they are scrambled. SKP ordered Sets bypass and do not advance the scrambler. SKP is a USB control code (K-code) that causes the descrambler to skip to the next. Fourth, data sets, SDS Ordered Sets, bypass the scrambler, but the scrambler advances. Fifth, all symbols of a SYNC ordered Set bypass the scrambler. The scrambling LFSR is initialized after the last Symbol of a SYNC ordered Set is transmitted. The descrambling LFSR is initialized after the last Symbol of a SYNC ordered set is received.

Sixth, the receivers evaluate Symbol 0 of control blocks to determine whether to advance their LFSR. If Symbol 0 of the Block is SKP or SKPEND then the LFSR is not advanced for any Symbol of that Block. Otherwise, the LFSR is advanced for all Symbols of the Block. Seventh, all 16 Symbols of a Data Block are scrambled and advance the scrambler. Eighth, for Symbols that need to be scrambled the least significant bit is scrambled first and the most significant bit is scrambled last. Ninth, the seed value for the LFSR is 1dbfbCh. Tenth and finally, every 16384 TSEQ sets a SYNC Ordered Set that shall be inserted to reset scrambler and to aid in block alignment.

However, there are challenges related with descrambling. The data communication starts after the training sequence as explained above. During the training sequence, some part of the training also gets descrambled. For training and data descrambling one needs to initialize the LFSR with the given seed value which is 0x1dbfbc. The seed value keeps advancing as the transmission progresses. One has to reinitialize the seed during SYNC pattern.

The extraction of the seed happens during the scenarios below in the following priority order. First, if the current acquisition contains both training and data communication including SYNC pattern then one just has to initialize the LFSR with initial value and then advance as the data communication happens. Second, if the current acquisition contains a SKP control block (average 40 blocks per acquisition), then the last 3 symbols of SKP control block contain the state of LFSR seed. The state of the LFSR can be further used for descrambling. Third, if the current acquisition contains only the data block, then latest state of the LFSR for the acquired data is unknown.

According to the existing prior art to extract the current state of the LFSR there are several approaches. One approach decodes the side band signal along with the received signal. To reset the LFSR for scrambling in decoding the side band signal one needs to initialize the debug register. However, side band signal solution requires additional probing of side band signal, which in turn requires an additional channel of the test and measurement instrument, which may involve a second probe, and decoding of the side band data, etc.

Another approach involves calculating all the different seeds and then using a search algorithm to look for alignment of the seed value with the current data to be descrambled. However, the search algorithm solution takes more time as the algorithm has to align the seed with data using search. To calculate number of seed values the below mentioned calculation method uses formula such as; 2²³−1, which equals 8,388,607 seed values. To traverse over the many seed values every time one hits the right seed take a lot of time while decreasing the performance of the descrambling process.

The embodiments herein address the problem mentioned in the prior art without using side band signal and not using any of the search algorithms.

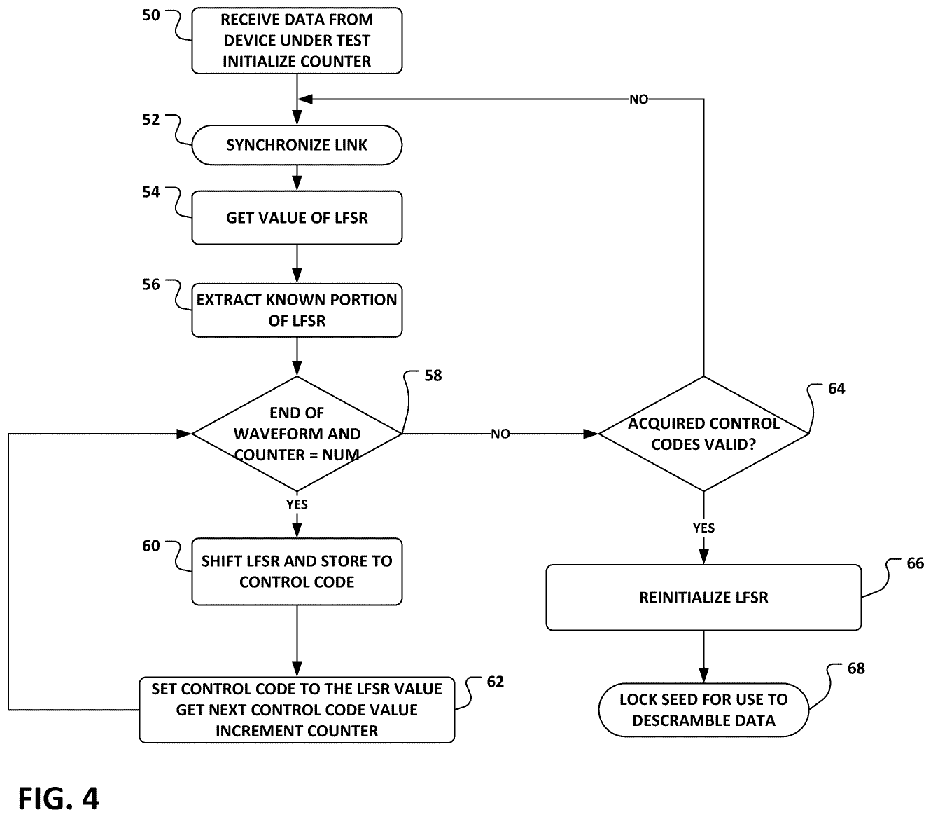

FIG. 4 shows an embodiment of a method of descrambling using the seed. The method is typically implemented by one or more processors in the test and measurement instrument configured to execute code embodying the method. The embodiment starts with reception of data from the DUT and initializing a counter to zero at 50. As discussed above, the embodiments begin after the link synchronizes at 52, which is when the data begins. At 54, the process acquires the current state of the LFSR. In one embodiment, the current state of the LFSR is 0x1dbfbc wherein four continuous scrambled values from the data being received as raw data are being used to align the seed to the current data.

A known portion of the LFSR is extracted at 56. In one embodiment, the known portion comprises the last eight bits of LFSR, bits 16-23 bits. The process extracts them bitwise by performing AND operation with the value of 0x7F8000 to obtain the LFSR value.

The process then enters an iterative portion, so first the state of the iterations needs to be checked at 58. If an AND between an end of waveform status and the counter being less than the predetermined number, at 60 the process shifts/rotates the known LFSR value some number of times and then stores the control code, which the USB standard refers to as K-codes. At 62, the control code is then set to the LFSR value, and the process returns to 58 and repeats until the counter reaches some predetermined number. A potential control code is stored at each iteration.

In one embodiment, the LFSR value is rotated four times using right shift with tap values 2, 4, 6, 7 at 60 to produce a new LFSR value. After the rotation, the new LFSR value is stored at 62 to be compared later at 64. The comparison may involve an exclusive OR operation (XOR) with the incoming data to determine whether the new LFSR value is a control code. Once the predetermined number of potential control codes are collected, or the waveform ends, the process moves to 64.

As an example, consider scrambled incoming data of 87, 144, 185, 24. When the data is compared to the LFSR using an XOR operation, the incoming data descrambles to 4B 4B 4B 36, which is a K-code for “Link Control Word Header.” In another example, the scrambled incoming data is 64, 44, 93, 44, and descrambles to 5A 5A, 5A, 5A, which corresponds to the K-code for “idle.”

At 64, the predetermined number of control characters are compared to validate the control codes. If they are valid control codes, the process reinitializes the LFSR at 66 by moving back by the predetermined number of times and the seed is locked at 68, and. The seed is then used for further descrambling. If the control codes are not valid, the process returns to just before the synchronization process at 52.

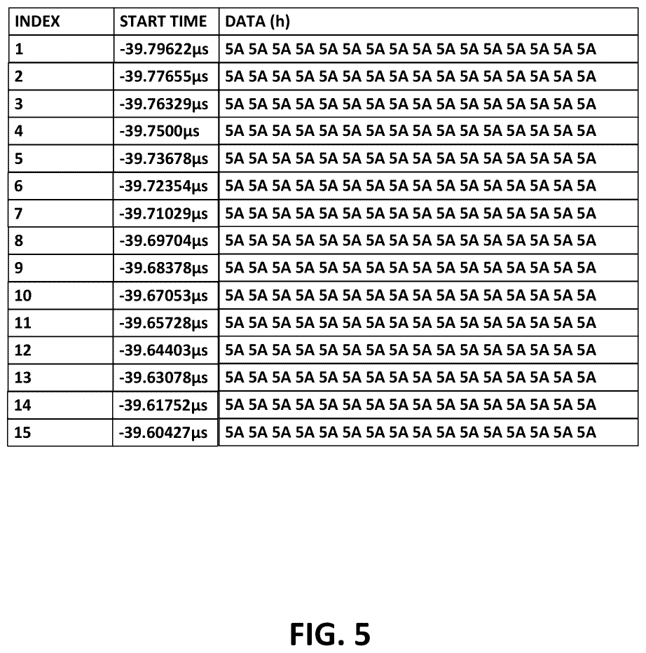

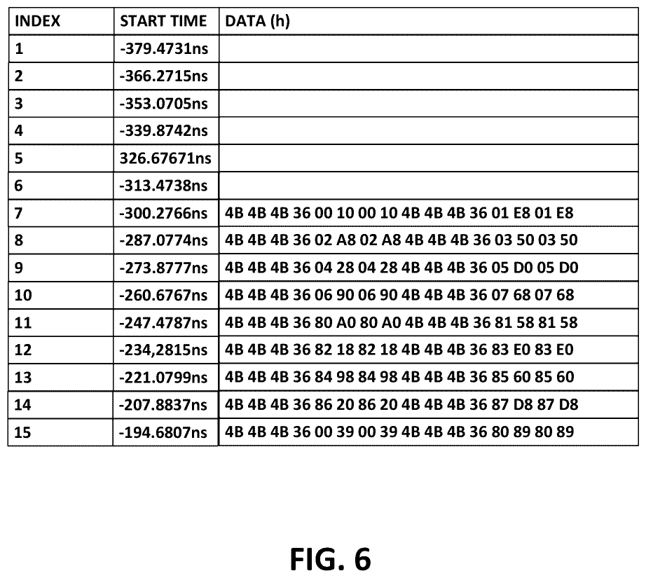

FIGS. 5 and 6 shows examples of instrument screens showing decoded data. FIG. 5 shows decoded data for the idle pattern after descrambling. FIG. 6 shows decoded data for a training mode.

As mentioned above, the embodiments have no need for additional probing of side band signals as the process uses the existing signal to extract the seed. There is therefore no need for using an additional channel for side band signal, decoding of the side band data, etc.

Using the known portion of the LFSR allows validation of the seed value dynamically. Validating the seed dynamically helps one to avoid using search algorithms there by increasing the efficiency and performance of the line encoding. The performance of the decode solution does miss any acquisitions and bits. The approach of the embodiments is fast enough to get the decode done as the approach uses only four symbols to extract and lock the seed.

The embodiments allow users to only need the differential probe/single ended probe only for USB signal capture. Extra probes and channels are not required to capture the side band signal. The efficiency of the extracted seed is better as existing 8 bits LFSR are being used and then rotated to get the proper seed. There are no additional parameters required like different search algorithms, side band signals etc. The embodiments comprise a user-friendly solution test the USB 3.x protocols as one must focus only on decode.

Aspects of the disclosure may operate on a particularly created hardware, on firmware, digital signal processors, or on a specially programmed general purpose computer including a processor operating according to programmed instructions. The terms controller or processor as used herein are intended to include microprocessors, microcomputers, Application Specific Integrated Circuits (ASICs), and dedicated hardware controllers. One or more aspects of the disclosure may be embodied in computer-usable data and computer-executable instructions, such as in one or more program modules, executed by one or more computers (including monitoring modules), or other devices. Generally, program modules include routines, programs, objects, components, data structures, etc. that perform particular tasks or implement particular abstract data types when executed by a processor in a computer or other device. The computer executable instructions may be stored on a non-transitory computer readable medium such as a hard disk, optical disk, removable storage media, solid state memory, Random Access Memory (RAM), etc. As will be appreciated by one of skill in the art, the functionality of the program modules may be combined or distributed as desired in various aspects. In addition, the functionality may be embodied in whole or in part in firmware or hardware equivalents such as integrated circuits, FPGA, and the like. Particular data structures may be used to more effectively implement one or more aspects of the disclosure, and such data structures are contemplated within the scope of computer executable instructions and computer-usable data described herein.

The disclosed aspects may be implemented, in some cases, in hardware, firmware, software, or any combination thereof. The disclosed aspects may also be implemented as instructions carried by or stored on one or more or non-transitory computer-readable media, which may be read and executed by one or more processors. Such instructions may be referred to as a computer program product. Computer-readable media, as discussed herein, means any media that can be accessed by a computing device. By way of example, and not limitation, computer-readable media may comprise computer storage media and communication media.

Computer storage media means any medium that can be used to store computer-readable information. By way of example, and not limitation, computer storage media may include RAM, ROM, Electrically Erasable Programmable Read-Only Memory (EEPROM), flash memory or other memory technology, Compact Disc Read Only Memory (CD-ROM), Digital Video Disc (DVD), or other optical disk storage, magnetic cassettes, magnetic tape, magnetic disk storage or other magnetic storage devices, and any other volatile or nonvolatile, removable or non-removable media implemented in any technology. Computer storage media excludes signals per se and transitory forms of signal transmission.

Communication media means any media that can be used for the communication of computer-readable information. By way of example, and not limitation, communication media may include coaxial cables, fiber-optic cables, air, or any other media suitable for the communication of electrical, optical, Radio Frequency (RF), infrared, acoustic or other types of signals.

### EXAMPLES

Illustrative examples of the disclosed technologies are provided below. An embodiment of the technologies may include one or more, and any combination of, the examples described below.

Example 1 is a test and measurement instrument, comprising: one or more channels to receive data from a device under test (DUT) through a test fixture, the data being transmitted by the DUT in accordance with the Universal Serial Bus (USB) protocol 3.x; and one or more processors configured to execute code that causes the one or more processors to: acquire a state of a linear feedback shift register (LFSR); extract a known portion of the LFSR as an LFSR value; shift the LFSR value a predetermined number of times to produce a new value of the LFSR; compare the new value of the LFSR to a value of incoming data received through the channel to determine if the value of the incoming data comprises a potential control code; repeat the shift of the LFSR value and compare the new value of the LFSR to acquire a predetermined number of potential control codes; compare the predetermined number of potential control codes to known control code values to determine if the potential control codes are valid; and when the potential control codes are valid, lock a seed used to descramble the remaining incoming data.

Example 2 is the test and measurement instrument of Example 1, wherein the code that causes the one or more processors to extract the value of the known portion of the LFSR comprises code that causes the one or more processors to extract the value of the known portion of the LFSR bit wise by performing an AND operation with 0x7F8000.

Example 3 is the test and measurement instrument of either of Examples 1 or 2, wherein the code that causes the one or more processors to shift the LFSR value one or more times comprises code that causes the one or more processors to shift the LFSR value four times to the right.

Example 4 is the test and measurement instrument of Example 3, wherein the code that causes the one or more processors to shift the LFSR value four times to the right comprises code that causes the one or more processors to shift the value of the known portion of the LFSR by 2, 4, 6, and 7.

Example 5 is the test and measurement instrument of any of Examples 1 through 4, wherein the code that causes the one or more processors to compare the new value of the LFSR to the value of incoming data comprises an exclusive OR operation.

Example 6 the test and measurement instrument of any of Examples 1 through 5, wherein the code that causes the one or more processors to repeat the shift of the LFSR value and the compare a predetermined number of times comprises code that causes the one or more processors to shift and compare four times.

Example 7 the test and measurement instrument of any of Examples 1 through 6, wherein the one or more processors are further configured to reinitialize the LFSR when the control codes are valid.

Example 8 is the test and measurement instrument of any of Examples 1 through 7, wherein the one or more processors are further configured to acquire the state of the LFSR and repeat the extract, shift, compare, repeat, and compare steps when the control codes are not valid control codes.

Example 9 is the test and measurement instrument of any of Examples 1 through 8, wherein the data from the test fixture does not include sideband signal data.

Example 10 is a method of descrambling USB 3.x data, comprising: receiving USB 3.x data from a device under test (DUT); acquiring a state of a linear feedback shift register (LFSR); extracting a value of a known portion of the LFSR as an LFSR value; shifting the LFSR value one or more times to produce a new value of the LFSR; comparing the new value of the LFSR to a value of incoming data received through the port to determine if the value of the incoming data comprises a potential control code; repeating the shifting of the LFSR value and the comparing to acquire a predetermined number of potential control codes; comparing the predetermined number of potential control codes to known control code values to determine if the potential control codes are valid; and when the potential control codes are valid, locking a seed used to descramble the remaining incoming data.

Example 11 is the method of Example 10, wherein extracting the LFSR value comprises extracting the value of the known portion of the LFSR bit wise by performing an AND operation with 0x7F8000.

Example 12 is the method of Example 11, wherein shifting the LFSR value one or more times comprises shifting the LFSR value four times to the right.

Example 13 is the method of Example 12, wherein shifting the LFSR value four times to the right comprises shifting the value of the known portion of the LFSR by 2, 4, 6, and 7.

Example 14 is the method of any of Examples 11 through 13, wherein comparing the new value of the LFSR to the value of incoming data comprises an exclusive OR operation.

Example 15 is the method of any of Examples 11 through 14, wherein repeating the shifting and comparing the predetermined number of times comprises the shifting and the comparing four times.

Example 16 is the method of any of Examples 11 through 15, further comprising reinitializing the LFSR when the control codes are valid.

Example 17 is the method of any of Examples 11 through 16, further comprising acquiring the state of the LFSR and performing the extracting, the shifting, the comparing, the repeating, and the comparing steps when the control codes are not valid.

Example 18 is the method of any of Examples 11 through 17, wherein receiving the data from the DUT comprises receiving the data without receiving sideband signals.

The previously described versions of the disclosed subject matter have many advantages that were either described or would be apparent to a person of ordinary skill. Even so, these advantages or features are not required in all versions of the disclosed apparatus, systems, or methods.

Additionally, this written description makes reference to particular features. It is to be understood that the disclosure in this specification includes all possible combinations of those particular features. Where a particular feature is disclosed in the context of a particular aspect or example, that feature can also be used, to the extent possible, in the context of other aspects and examples.

Also, when reference is made in this application to a method having two or more defined steps or operations, the defined steps or operations can be carried out in any order or simultaneously, unless the context excludes those possibilities.

All features disclosed in the specification, including the claims, abstract, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent, or similar purpose, unless expressly stated otherwise.

Although specific examples of the invention have been illustrated and described for purposes of illustration, it will be understood that various modifications may be made without departing from the spirit and scope of the invention. Accordingly, the invention should not be limited except as by the appended claims.

1. A test and measurement instrument, comprising:
one or more channels to receive data from a device under test (DUT) through a test fixture, the data being transmitted by the DUT in accordance with the Universal Serial Bus (USB) protocol 3.x; and
one or more processors configured to execute code that causes the one or more processors to:
acquire a state of a linear feedback shift register (LFSR);
extract a known portion of the LFSR as an LFSR value;
shift the LFSR value a predetermined number of times to produce a new value of the LFSR;
compare the new value of the LFSR to a value of incoming data received through the channel to determine if the value of the incoming data comprises a potential control code;
repeat the shift of the LFSR value and the compare of the new value of the LFSR to acquire a predetermined number of potential control codes;
compare the predetermined number of potential control codes to known control code values to determine if the potential control codes are valid and
when the potential control codes are valid, lock a seed used to descramble the remaining incoming data.

2. The test and measurement instrument as claimed in claim 1, wherein the code that causes the one or more processors to extract the value of the known portion of the LFSR comprises code that causes the one or more processors to extract the value of the known portion of the LFSR bit wise by performing an AND operation with 0x7F8000.

3. The test and measurement instrument as claimed in claim 1, wherein the code that causes the one or more processors to shift the LFSR value one or more times comprises code that causes the one or more processors to shift the LFSR value four times to the right.

4. The test and measurement instrument as claimed in claim 3, wherein the code that causes the one or more processors to shift the LFSR value four times to the right comprises code that causes the one or more processors to shift the value of the known portion of the LFSR by 2, 4, 6, and 7.

5. The test and measurement instrument as claimed in claim 1, wherein the code that causes the one or more processors to compare the new value of the LFSR to the value of incoming data comprises an exclusive OR operation.

6. The test and measurement instrument as claimed in claim 1, wherein the code that causes the one or more processors to repeat the shift of the LFSR value and the compare a predetermined number of times comprises code that causes the one or more processors to shift and compare four times.

7. The test and measurement instrument as claimed in claim 1, wherein the one or more processors are further configured to reinitialize the LFSR when the control codes are valid.

8. The test and measurement instrument as claimed in claim 1, wherein the one or more processors are further configured to acquire the state of the LFSR and repeat the extract, shift, compare, repeat, and compare steps when the control codes are not valid control codes.

9. The test and measurement instrument as claimed in claim 1, wherein the data from the test fixture does not include sideband signal data.

10. A method of descrambling USB 3.x data, comprising:
receiving USB 3.x data from a device under test (DUT);
acquiring a state of a linear feedback shift register (LFSR);
extracting a value of a known portion of the LFSR as an LFSR value;
shifting the LFSR value one or more times to produce a new value of the LFSR;
comparing the new value of the LFSR to a value of incoming data received through the port to determine if the value of the incoming data comprises a potential control code;
repeating the shifting of the LFSR value and the comparing to acquire a predetermined number of potential control codes;
comparing the predetermined number of potential control codes to known control code values to determine if the potential control codes are valid; and
when the potential control codes are valid, locking a seed used to descramble the remaining incoming data.

11. The method as claimed in claim 10, wherein extracting the LFSR value comprises extracting the value of the known portion of the LFSR bit wise by performing an AND operation with 0x7F8000.

12. The method as claimed in claim 11, wherein shifting the LFSR value one or more times comprises shifting the LFSR value four times to the right.

13. The method as claimed in claim 12, wherein shifting the LFSR value four times to the right comprises shifting the value of the known portion of the LFSR by 2, 4, 6, and 7.

14. The method as claimed in claim 10, wherein comparing the new value of the LFSR to the value of incoming data comprises an exclusive OR operation.

15. The method as claimed in claim 10, wherein repeating the shifting and comparing the predetermined number of times comprises the shifting and the comparing four times.

16. The method as claimed in claim 10, further comprising reinitializing the LFSR when the control codes are valid.

17. The method as claimed in claim 10, further comprising acquiring the state of the LFSR and performing the extracting, the shifting, the comparing, the repeating, and the comparing steps when the control codes are not valid.

18. The method as claimed in claim 10, wherein receiving the data from the DUT comprises receiving the data without receiving sideband signals.
